(19) United States
(12) Patent Application Publication
(10) Pub. No.: US 2026/0300214 A1
(43) Pub. Date: Oct. 1, 2026

(54) DUMMY MEMORY CIRCUIT STRUCTURE, COMPUTER DEVICE THEREOF AND OPERATION METHOD THEREOF

(71) Applicant: V-COLOR TECHNOLOGY INC., New Taipei City (TW)

(72) Inventor: Tien-Shun HO, New Taipei City (TW)

(21) Appl. No.: 19/309,606

(22) Filed: Aug. 26, 2025

(30) Foreign Application Priority Data
Mar. 25, 2025 (TW) 114111251

(51) Int. Cl. G06F 13/42; H05B 45/37

(52) U.S. Cl. CPC G06F 13/4282; H05B 45/37; G06F 2213/0016

(57) ABSTRACT

A dummy memory circuit structure and operation method thereof is disclosed. The dummy memory circuit structure involves a circuit substrate, configured to be detachably inserted into a slot of a motherboard; a microcontroller unit, disposed on the circuit substrate; a light emitting diode control chip, disposed on the circuit substrate, and the light emitting diode control chip is electrically connected to the microcontroller unit through the circuit substrate; and at least one light emitting diode, disposed on the circuit substrate, and the at least one light emitting diode is electrically connected to the light emitting diode control chip through the circuit substrate; wherein the microcontroller unit sends a dummy module specification information to a central processing unit for identification of the circuit substrate, so that the central processing unit can communicate with the microcontroller unit.

### CROSS - REFERENCE TO RELATED APPLICATION

This application claims priority to Taiwan Application No. 114111251, filed Mar. 25, 2025, which is herein incorporated by reference in its entirety.

### BACKGROUND

### Field of Invention

The present disclosure relates to a technical field of memory, and more particularly, a dummy memory circuit structure and an operating method thereof that can communicate electrical signals without identifying a module specification information of the dummy memory.

### Description of Related Art

The conventional dummy memory structure 10' may be referred to as shown in FIGS. 12, and 3. The conventional dummy memory structure 10' may include a circuit substrate 100', a sequence presence detection hub (SPD Hub) 200', a light emitting diode control chip 300' and at least one light emitting diode 400'. The circuit substrate 100' may be inserted into a slot (not shown) of a motherboard (not shown). The circuit substrate 100' does not include physical memory volume integrated circuit (IC) chips. In addition to reducing costs, one of its added benefits is that it will not cause interference from antenna effect. The slot may be, for example, a DIMM (Dual In-line Memory Module) slot. As shown in FIG. 6 , a signal sent by a central processing unit of the motherboard (not shown) may be transmitted to the HSCL (Host Bus-Input Clock)/HSDA (Host Bus-Data Input/Output) pins of the serial presence detection hub 200’ through the HSCL/HSDA pins of the slot, and then further transmitted from the LSCL (Local Bus-Output Clock)/LSDA (Local Bus-Data Input/Output) pins of the serial presence detection hub 200’ to the SCLK (Serial Clock)/SDAT (Serial Data Input and Output) pins of the light-emitting diode control chip 300’.

At this time, since the serial presence detection hub 200' must comply with the JEDEC (Joint Electron Device Engineering Council) specification, the BIOS (Basic Input/Output System) of different central processing units of different manufacturers will identify the module specification information of the serial presence detection hub 200' in the dummy memory structure 10'. For example, as shown in FIG. 4, taking a memory with a capacity of 16 GB (i.e., non-dummy memory) as an example, the data content contained in the serial presence detection hub 200' includes the module specification information D1' of the JEDEC specification, so that the electronic device (e.g., computer) may directly perform the subsequent booting and control operation of the light-emitting diode 400'. Please refer to FIG. 5 again, if it is a dummy memory (for example, dummy memory structure 10'), the data content of the addresses other than address 0x200 and 0x201 are 00, and the data content of 86 and 6D are stored at addresses 0x200 and 0x201 respectively, which correspond to a manufacturer's identification code for the dummy memory.

As mentioned above, since the BIOS of different CPUs will identify the module specification information D1' of the serial presence detection hub 200' in the dummy memory structure 10', if the central processing unit is manufactured by or affiliated with Intel (i.e., on the Intel platform), the data content of the module specification information D1' will be detected and the data content will be accepted and the subsequent boot and control operation of the light emitting diode 400' will be performed; however, if the central processing unit is manufactured by or affiliated with AMD (i.e., on an AMD platform), it has been observed that the data content of the module specification information D1' will not be detected and the data content of the module specification information D1' will not be accepted, resulting in the subsequent boot action not being performed.

Therefore, how to enable the motherboard with different central control units to be able to perform subsequent operations such as booting electronic devices such as computers and controlling light emitting diodes without being affected by the dummy memory structure is a major problem that needs to be solved.

### SUMMARY

An objective of the present invention is to provide a dummy memory circuit structure and an operation method thereof. By setting up the microcontroller unit and removing the serial presence detection hub, even if it is used on a motherboard with different central processing units, it is possible to directly boot subsequent electronic devices such as computers and control light-emitting diodes without identifying the data content of the dummy memory circuit structure itself.

In order to achieve the aforementioned objective, the present invention provides a dummy memory circuit structure. The dummy memory circuit structure includes a circuit substrate, configured to be detachably inserted into a slot of a motherboard on which a central processing unit is disposed; a microcontroller unit, disposed on the circuit substrate; a light emitting diode control chip disposed on the circuit substrate, being electrically connected to the microcontroller unit through the circuit substrate; and at least one light emitting diode, disposed on the circuit substrate, and being electrically connected to the light emitting diode control chip through the circuit substrate. The microcontroller unit is configured to send a dummy module specification information to the central processing unit for identification of the circuit substrate, so that the central processing unit makes communication with the microcontroller unit. In a preferred embodiment of the present invention, the microcontroller unit is configured to send a dummy module specification information to the central processing unit for identification of the circuit substrate, so that the central processing unit makes communication with the microcontroller unit, irrespective of the central processing unit’s manufacturer.

In a preferred embodiment of the present invention, the dummy module specification information is configured to simulate a module specification information which meets JEDEC standards.

In a preferred embodiment of the present invention, the microcontroller unit is configured to send a dummy module specification information by generating a clock line signal through a serial communication bus interface of the microcontroller unit, outputting the clock line signal through a HSCL pin of the slot, and outputting a corresponding data line signal through a HSDA pin of the slot to transmit the clock line signal and the data line signal to the central processing unit.

In a preferred embodiment of the present invention, the microcontroller unit further includes a serial communication bus interface.

In a preferred embodiment of the present invention, the serial communication bus interface comprises I²C, I³C or a combination thereof.

In a preferred embodiment of the present invention, the microcontroller unit further comprises a first device pin and a second device pin, and the light emitting diode control chip comprises a second serial clock pin and a second serial data input and output pin. The first device pin is coupled to the second serial clock pin, and the second device pin is coupled to the second serial data input and output pin.

In a preferred embodiment of the present invention, the dummy memory circuit structure further includes a second voltage conversion circuit module, disposed on the circuit substrate, and comprising a second input end and a second output end. The light emitting diode control chip further comprises a second power providing pin. The second input end is electrically connected to the motherboard, the second output end is electrically connected to the second power providing pin, so that the second voltage conversion circuit module is electrically connected to the motherboard and the light emitting diode control chip. The second voltage conversion circuit module further includes a third input end and a third output end. The light emitting diode control chip further comprises a third power providing pin. The third input end is electrically connected to the motherboard, the third output end is electrically connected to the third power providing pin, so that the second voltage conversion circuit module is electrically connected to the motherboard and the at least one light emitting diode.

In a preferred embodiment of the present invention, the second voltage conversion circuit module further comprises a third input end and a third output end. The light emitting diode control chip further comprises a third power providing pin. The third input end is electrically connected to the motherboard, the third output end is electrically connected to the third power providing pin, so that the second voltage conversion circuit module is electrically connected to the motherboard and the at least one light emitting diode. In a preferred embodiment of the present invention, the first voltage conversion circuit module converts a power providing voltage provided by the motherboard into a first voltage and supplies power to the microcontroller, so that the microcontroller unit will be able to make communication with the central processing unit and capable of receiving a first control signal from the central processing unit.

In a preferred embodiment of the present invention, the second voltage conversion circuit module converts the power providing voltage provided by the motherboard into a second voltage and supplies power to the light emitting diode control chip and the at least one light emitting diode, so that the light emitting diode control chip will be able to make communication with the microcontroller unit and capable of receiving a second control signal from the microcontroller unit.

In a preferred embodiment of the present invention, the power supply voltage is greater than or equal to the second voltage, and the second voltage is greater than the first voltage.

In a preferred embodiment of the present invention, the microcontroller unit and the light emitting diode control chip are integrated into a single chip.

In further embodiments, the present invention provides a computer device. The computer device includes a motherboard, a circuit substrate, a microcontroller unit, a light emitting diode control chip, and at least one light emitting diode. A central processing unit is disposed on the motherboard. The circuit substrate is detachably inserted into a slot of the motherboard. The microcontroller unit is disposed on the circuit substrate. The light emitting diode control chip is disposed on the circuit substrate, and the light emitting diode control chip is electrically connected to the microcontroller unit through the circuit substrate 100. The at least one light emitting diode is disposed on the circuit substrate and electrically connected to the light emitting diode control chip through the circuit substrate. The microcontroller unit sends a dummy module specification information to the central processing unit for identification of the circuit substrate, so that the central processing unit can make communication with the microcontroller unit. In a preferred embodiment of the present invention, the microcontroller unit sends a dummy module specification information to the central processing unit for identification of the circuit substrate, so that the central processing unit can make communication with the microcontroller unit, irrespective of the central processing unit’s manufacturer.

In order to achieve the aforementioned objective, the present invention provides an operation method of a dummy memory circuit structure. The operation method includes an addressing step: inserting a dummy memory circuit structure into a slot of a motherboard to address the dummy memory circuit structure, wherein a microcontroller unit included in the dummy memory circuit structure sends a dummy module specification information to a central processing unit of the motherboard, so that the central processing unit can make communication with the microcontroller unit; a first stage communication step: sending a first control signal by a central processing unit of the motherboard, and transmitting the first control signal is to a first serial clock pin and a first serial data input and output pin of a microcontroller unit included in the dummy memory circuit structure through a HSCL (Host Bus-Input Clock) / HSDA (Host Bus-Data Input/Output) pin of the slot; a second stage communication step: processing the first control signal by the microcontroller unit to generate a second control signal, and outputting the second control signal through the first serial clock pin and the first serial data input and output pin of the microcontroller unit, and transmitting the second control signal to a second serial clock pin and a second serial data input and output pin of a light emitting diode chip included in the dummy memory circuit structure; and a light emitting diode driving step: after communication between the central processing unit and the microcontroller unit has been made, and after receiving the second control signal from the microcontroller unit, the light emitting diode chip 300 provides a driving current to the at least one light emitting diode included in the dummy memory circuit structure so as to control the operation of at least one light emitting diode included in the dummy memory circuit structure.

In a preferred embodiment of the present invention, the addressing step includes generating a clock line signal and a corresponding data line signal for transmission to the central processing unit.

In a preferred embodiment of the present invention, the microcontroller unit further comprises a first device pin and a second device pin. In the first stage communication step, the first device pin is coupled to the second serial clock pin, and the second device pin is coupled to the second serial data input and output pin.

In a preferred embodiment of the present invention, the addressing step, the dummy module specification information simulates a module specification information which meets JEDEC standards, so that the central processing unit can make communication with the microcontroller unit. In a preferred embodiment of the present invention, the addressing step, the dummy module specification information simulates a module specification information which meets JEDEC standards, so that the central processing unit can make communication with the microcontroller unit, irrespective of the central processing unit’s manufacturer.

In a preferred embodiment of the present invention, the first stage communication step further includes converting a power supply voltage provided by the motherboard into a first voltage through a first voltage conversion circuit module included in the dummy memory circuit structure and providing the first voltage to the microcontroller unit.

In a preferred embodiment of the present invention, the second stage communication step further includes converting the power supply voltage provided by the motherboard into a second voltage through a second voltage conversion circuit module included in the dummy memory circuit structure and providing the second voltage to a light emitting diode control chip and the at least one light emitting diode.

In a preferred embodiment of the present invention, the power supply voltage is greater than or equal to the second voltage, and the second voltage is greater than the first voltage.

In a preferred embodiment of the present invention, the power supply voltage is 5V, the first voltage is 1V, and the second voltage is 3.3V to 5V.

### BRIEF DESCRIPTION OF THE DRAWINGS

Aspects of the present invention are best understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 is a schematic diagram of one side of a conventional dummy memory structure.

FIG. 2 is a schematic diagram of another side of the conventional dummy memory structure.

FIG. 3 is a circuit block diagram of the conventional dummy memory structure.

FIG. 4 is a schematic diagram showing the specifications of a conventional non-dummy memory structure with capacity.

FIG. 5 is a schematic diagram showing the specifications of the conventional dummy memory structure.

FIG. 6 is a circuit connection diagram of the conventional dummy memory structure.

FIG. 7 is a schematic diagram of one side of the dummy memory circuit structure of the present invention.

FIG. 8 is a schematic diagram of another side of the dummy memory circuit structure of the present invention.

FIG. 9 is a circuit block diagram of the dummy memory circuit structure of the present invention.

FIG. 10 is a circuit connection diagram of the dummy memory circuit structure of the present invention.

FIG. 11 is a flow chart of an operation method of the dummy memory circuit structure of the present invention.

### DETAILED DESCRIPTION

It will be appreciated that, although specific embodiments of the present invention are described herein for purposes of illustration, various modifications may be made without departing from the spirit and scope of the present invention.

In the following description, certain specific details are set forth in order to provide a thorough understanding of various aspects of the disclosed subject matter. However, the disclosed subject matter may be practiced without these specific details. In some instances, well-known structures and methods of power delivery comprising embodiments of the subject matter disclosed herein have not been described in detail to avoid obscuring the descriptions of other aspects of the present invention.

Unless the context requires otherwise, throughout the specification and claims that follow, the word “comprise,” “have,” “include,” and variations thereof, such as “comprises,” “comprising,” “having,” “including” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present invention.

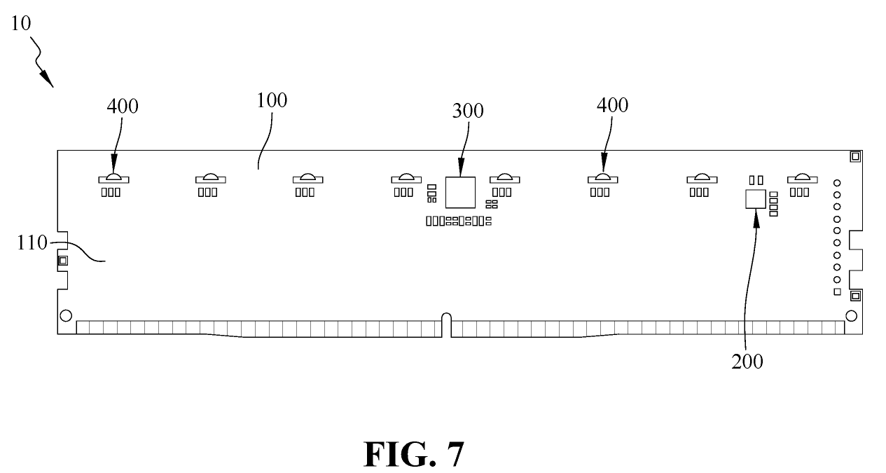

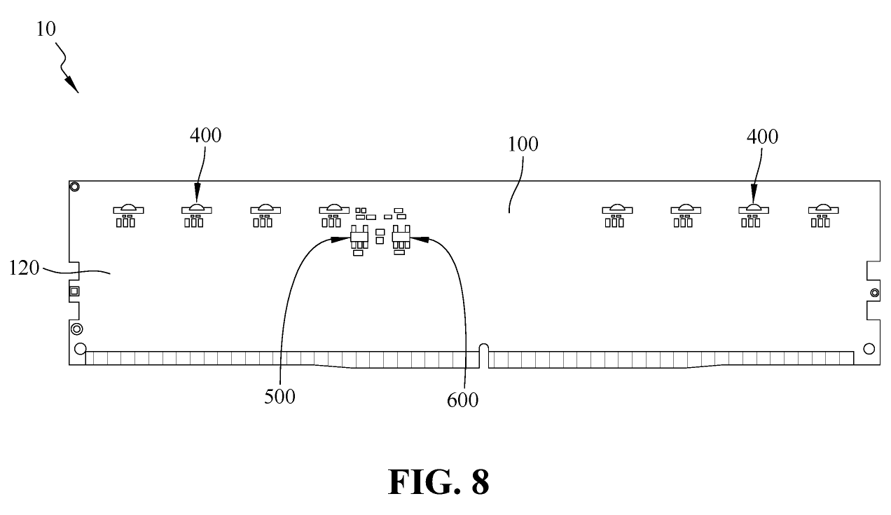

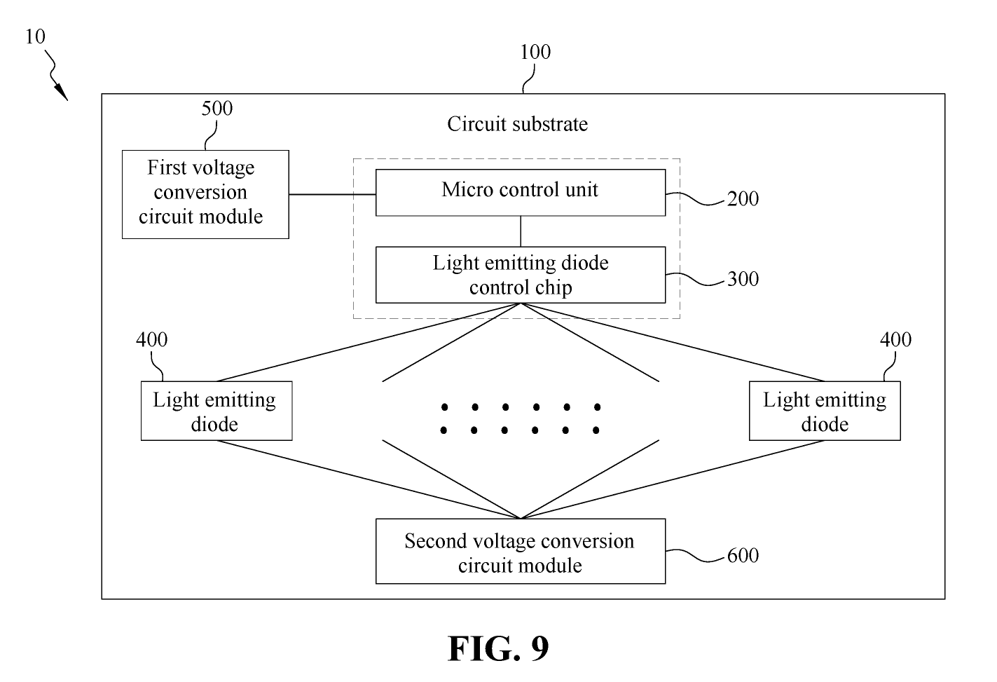

FIG. 7 is a schematic diagram of one side of the dummy memory circuit structure of the present invention. FIG. 8 is a schematic diagram of another side of the dummy memory circuit structure of the present invention. FIG. 9 is a circuit block diagram of the dummy memory circuit structure of the present invention.

Please refer to FIGS. 7 to 9. The dummy memory circuit structure 10 of the present invention includes a circuit substrate 100, a microcontroller unit 200, a light emitting diode (LED) control chip 300, and at least one light emitting diode (LED) 400. The communication between the components of the present invention may be performed via a serial communication bus, and the serial communication bus may be, for example, I2C (Inter-Integrated Circuit) and/or I3C (Improved Inter Integrated Circuit), but not limited thereto.

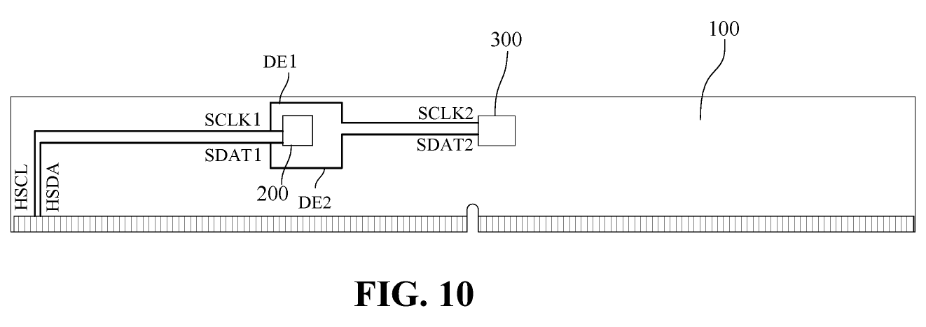

The circuit substrate 100 is configured to be detachably inserted into a slot (not shown) of a motherboard (not shown). In some embodiments, for example, the slot (not shown) may be a DIMM slot, but not limited thereto. In some embodiments, the circuit substrate 100 may include a first surface 110 (as shown in FIG. 7) and a second surface 120 (as shown in FIG. 8). As known in the prior art, the slot includes a Host Bus-Input Clock (HSCL) pin and a Host Bus-Data Input/Output (HSDA) pin. The symbols, HSCL and HSDA in FIG. 10 additionally refers to corresponding positions connected to the HSCL pin and the HSDA pin in the slot, rather than merely positions of the HSCL pin and the HSDA pin being disposed on the circuit substrate 100.

The microcontroller unit 200 is a MCU (Microcontroller Unit), which may be disposed on the circuit substrate 100. In some embodiments, as shown in FIG. 7, the microcontroller unit 200 may be disposed on the first surface 110 of the circuit substrate 100. In an embodiment of the present invention, the microcontroller unit 200 sends a dummy module specification information, which simulates a module specification information that meets JEDEC standards so as to be identified by the central processing unit, to a central processing unit, such that the central processing unit can communicate with the microcontroller unit 200 after receiving the dummy module specification information. Thus, being different from conventional memory modules, the dummy memory circuit structure 10 of the present invention does not simply store module specification information which can be accessed by the central processing unit, but the microcontroller unit 200 actively sends the dummy module specification information to the central processing unit for identification. Because the dummy module specification information simulates the module specification information which meets JEDEC standards, the dummy module specification information can be identified by the central processing unit, such that the communication between the central processing unit and the microcontroller unit 200 can be established after the dummy module specification information is sent to the central processing unit; that is, the initialization for the dummy memory circuit structure 10 can be completed by its sending the dummy module specification information to the central processing unit. In a specific embodiment of the present invention, a DIMM slot addressing initialization is retained by integrating a first serial clock pin SCLK1 and a first serial data input and output pin SDAT1 into the microcontroller unit 200. As shown in FIG. 10, the microcontroller unit 200 includes the first serial clock pin SCLK1 and the first serial data input and output pin SDAT1. Furthermore, the microcontroller unit 200 further includes a first device pin DE1 and a second device pin DE2 for being connected to other chips, including but not limited to the LED control chip 300, to transmit the generated clock line signal via the first device pin DE1 and the generated data line signal via the second device pin DE2 for downstream control.

The light-emitting diode control chip 300 may be set on the circuit substrate 100. In some embodiments, as shown in FIG. 7, the LED control chip 300 may be disposed on the first surface 110 of the circuit substrate 100. As shown in FIG. 10, the light-emitting diode control chip 300 includes a second serial clock pin SCLK2 and a second serial data input and output pin SDAT2.

At least one light-emitting diode 400 may be disposed on the circuit substrate 100. In some embodiments, the light emitting diode 400 may be disposed on the first surface 110, on the second surface 120, and/or on both the first surface 110 and the second surface 120 of the circuit substrate 100 (as shown in FIGS. 7 and 8). In some embodiments, the LED 400 may be electrically connected to the LED control chip 300 through the circuit substrate 100. In some embodiments, the number of LEDs 400 may be increased or decreased based on demand. In some embodiments, the microcontroller unit 200 and the LED control chip 300 may be integrated into a single chip.

In some embodiments, the dummy memory circuit structure 10 of the present invention further includes a first voltage conversion circuit module 500. The first voltage conversion circuit module 500 may be disposed on the circuit substrate 100. In some embodiments, as shown in FIG. 8, the first voltage conversion circuit module 500 may be disposed on the second surface 120 of the circuit substrate 100. In some embodiments, the first voltage conversion circuit module 500 may be electrically connected to a motherboard (not shown) and the microcontroller unit 200. Specifically, the first voltage conversion circuit module 500 includes a first input end and a first output end, and the microcontroller unit 200 further comprises a first power providing pin. The first input end of the first voltage conversion circuit module 500 is electrically connected to the motherboard, and the first output end of the first voltage conversion circuit module 500 is electrically connected to the first power providing pin of the microcontroller unit 200, so that the first voltage conversion circuit module 500 is electrically connected to the motherboard and the microcontroller unit 200. In some embodiments, the first voltage conversion circuit module 500 is configured to convert the power providing voltage provided by the motherboard into a second voltage and to supply power to the light emitting diode control chip 300 and the at least one light emitting diode, so that the light emitting diode control chip 300 can make communication with the microcontroller unit 200 and be capable of receiving a second control signal from the microcontroller unit 200. In some embodiments, the first voltage conversion circuit module 500 may convert a 5V voltage (i.e., a power supply voltage) provided by a motherboard (not shown) into a 1V voltage (i.e., a first voltage) and supply power to the microcontroller unit 200.

In some embodiments, the dummy memory circuit structure 10 of the present invention further includes a second voltage conversion circuit module 600. The second voltage conversion circuit module 600 may be disposed on the circuit substrate 100. In some embodiments, as shown in FIG. 8, the second voltage conversion circuit module 600 may be disposed on the second surface 120 of the circuit substrate 100. In some embodiments, the second voltage conversion circuit module 600 may be electrically connected to a main board (not shown), the LED control chip 300 and each LED 400. Specifically, the second voltage conversion circuit module 600 includes a second input end, a second output end, a third input end and a third output end, the LED control chip 300 further includes a second power providing pin and the at least one light emitting diode 400 includes a third power providing pin. The second input end of the second voltage conversion circuit module 600 is electrically connected to the motherboard, and the second output end of the second voltage conversion circuit module 600 is electrically connected to the second power providing pin of the LED control chip 300, so that the second voltage conversion circuit module 600 is electrically connected to the motherboard and the LED control chip 300. The third input end of the second voltage conversion circuit module 600 is electrically connected to the motherboard, and the third output end of the second voltage conversion circuit module 600 is electrically connected to the third power providing pin of the at least one light emitting diode 400, so that the second voltage conversion circuit module 600 is electrically connected to the motherboard and the at least one light-emitting diode 400. In some embodiment, the second voltage conversion circuit module 600 is configured to convert the power providing voltage provided by the motherboard into a second voltage and to supply power to the light emitting diode control chip 300 and the at least one light emitting diode 400, so that the light emitting diode control chip 300 can make communication with the microcontroller unit 200 and be capable of receiving a second control signal from the microcontroller unit 200. In some embodiments, the second voltage conversion circuit module 600 may convert a 5V voltage (i.e., a power supply voltage) provided by a motherboard (not shown) into a 3.3V to 5V voltage (i.e., a second voltage) and supply power to the LED control chip 300 and each LED 400.

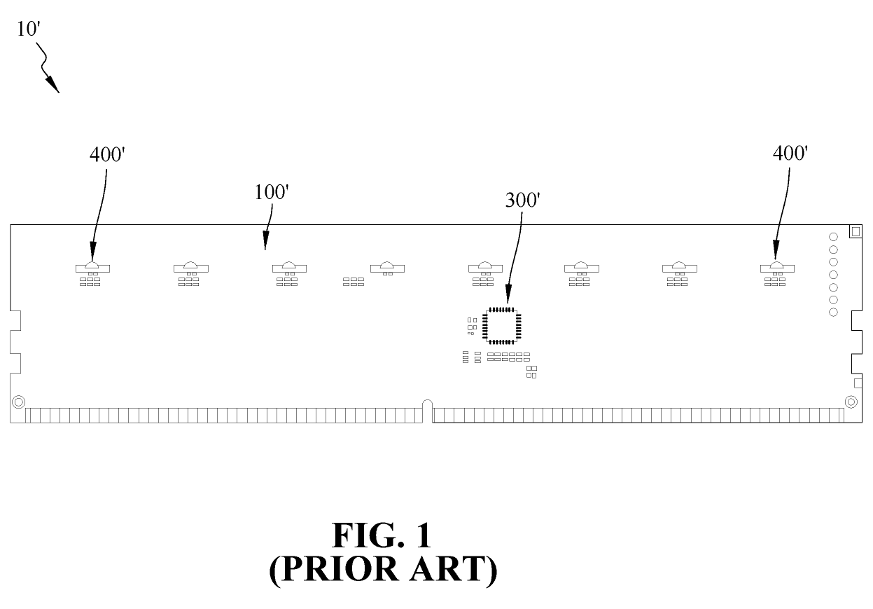

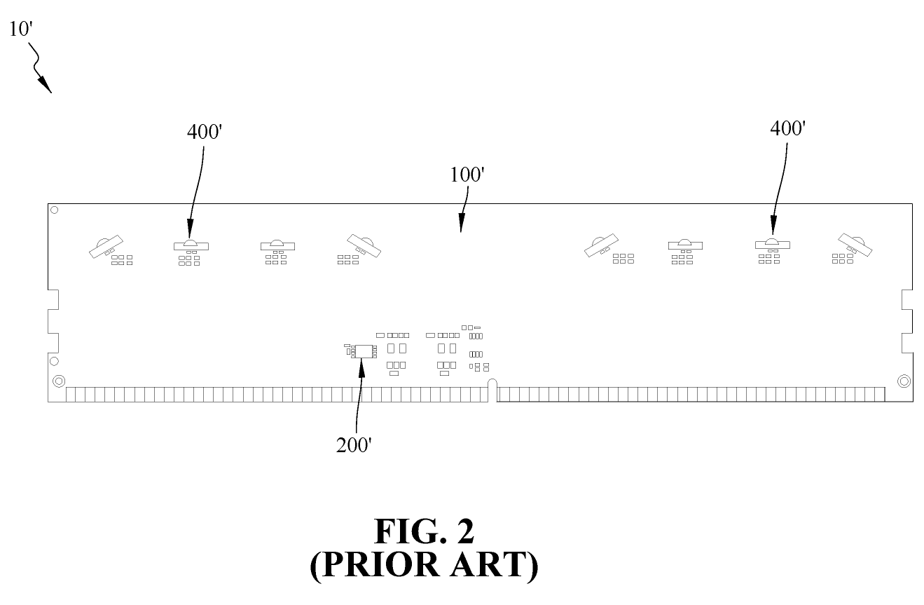

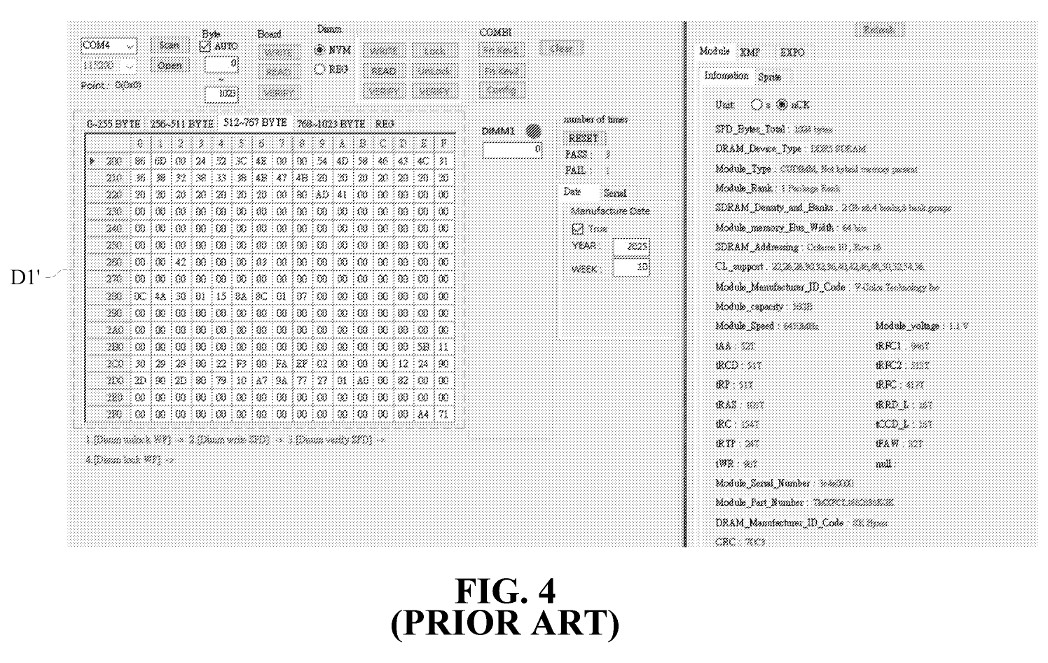

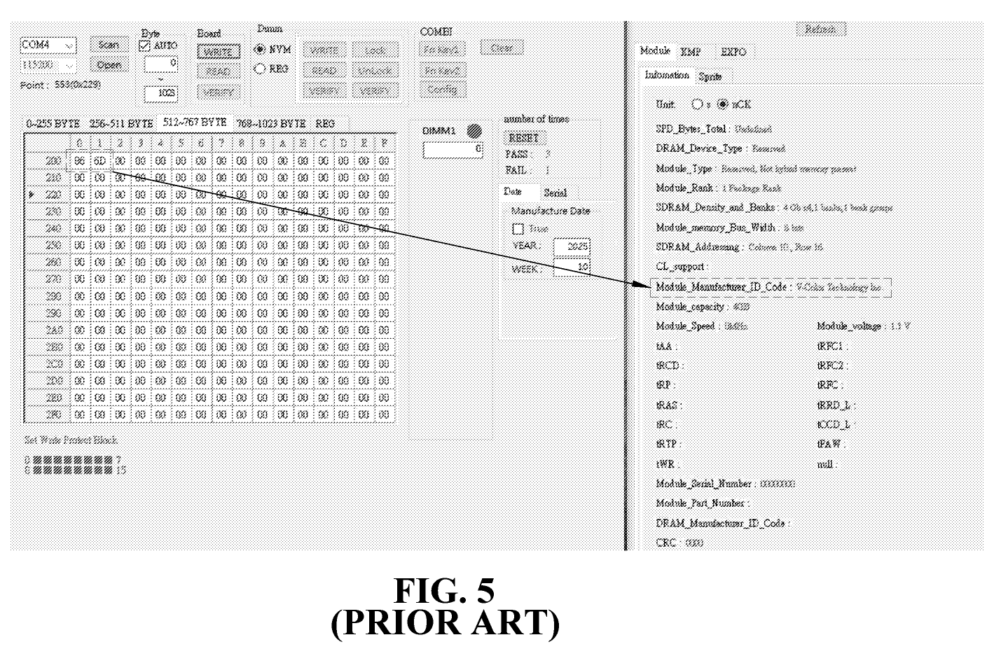

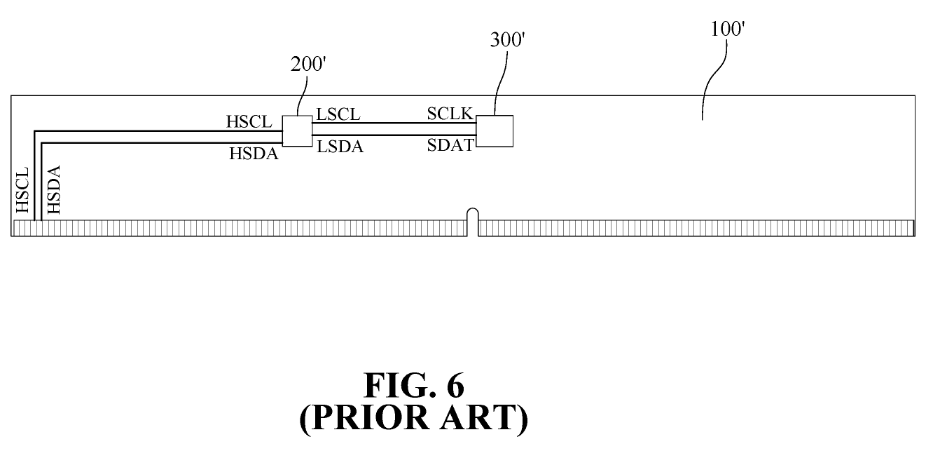

Compared to the conventional dummy memory structure 10' of FIGS. 1 to 6 above, the microcontroller unit 200 of the memory circuit structure 10 of the present invention sends a dummy module specification information to a central processing unit (not shown) on a motherboard (not shown), wherein the dummy module specification information can be identified by the central processing unit to establish communication between the central processing unit and the microcontroller unit 200 after the central processing unit receives the dummy module specification information. In an embodiment of the present invention, the dummy module specification information simulates a module specification information which meets JEDEC standards, so that the central processing unit can make communication with the microcontroller unit 200 regardless of whom the central processing unit was manufactured by (such as Intel or AMD). That is, the central processing unit (not shown) does not need to identify a module specification information of the sequence presence detection hub 200' any longer as is the conventional practice; thereby, an electronic device (not shown) (for example, a computer) corresponding to the motherboard (not shown) may be directly booted and perform subsequent operations to control the light emitting diode 400. In an embodiment of the present invention, the dummy module specification information comprises a clock line signal and a data line signal. When the circuit substrate 100 is inserted into the slot of the motherboard, the first serial clock pin SCLK1 is coupled to the HSCL pin HSCL and the first serial data input and output pin SDAT1 is coupled to the HSDA pin HSDA, so that the microcontroller unit 200 can make communication with the central processing unit disposed on the motherboard by providing the clock line signal and the data line signal. Then, the light emitting diode chip 300 sends a third control signal to the at least one light emitting diode 400 based on a first control signal from the central processing unit to activate the at least one light emitting diode 400.

Further embodiments of the present invention provide a computer device. The computer device includes a motherboard (not shown), a circuit substrate 100, a microcontroller unit 200, a light emitting diode control chip 300, and at least one light emitting diode 400. A central processing unit is disposed on the motherboard. The circuit substrate 100 is detachably inserted into a slot (not shown) of the motherboard. The microcontroller unit 200 is disposed on the circuit substrate 100. The light emitting diode control chip 300 is disposed on the circuit substrate 100, and the light emitting diode control chip 300 is electrically connected to the microcontroller unit 200 through the circuit substrate 100. The at least one light emitting diode 400 is disposed on the circuit substrate and electrically connected to the light emitting diode control chip 300 through the circuit substrate 100. The microcontroller unit 200 sends a dummy module specification information to the central processing unit for identification of the circuit substrate 100, so that the central processing unit can make communication with the microcontroller unit 200.

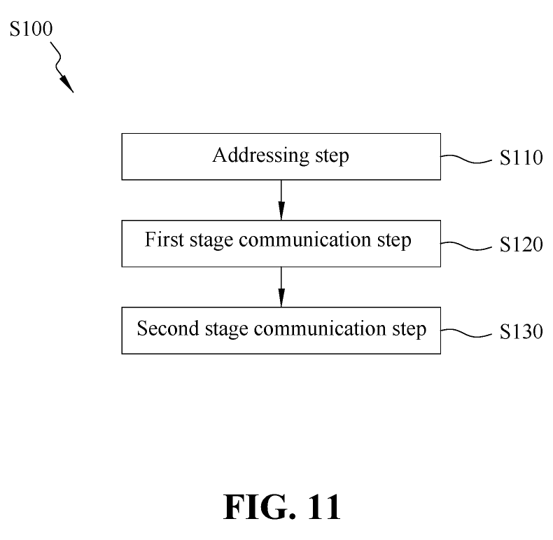

FIG. 10 is a circuit connection diagram of the dummy memory circuit structure of the present invention. FIG. 11 is a flow chart of an operation method of the dummy memory circuit structure of the present invention.

Referring to FIGS. 10 and 11, the operating method S100 of the dummy memory circuit structure (i.e., the dummy memory circuit structure10) of the present invention may include steps S110, S120, and S130. The components used correspond to the components and component numerals of the aforementioned dummy memory circuit structure 10.

Step S110 is an addressing step. Step S110 involves inserting a dummy memory circuit structure 10 into a slot (not shown) of a motherboard (not shown) to address the dummy memory circuit structure, wherein a microcontroller unit 200 included in the dummy memory circuit structure 10 sends a dummy module specification information to a central processing unit of the motherboard, so that the central processing unit can make communication with the microcontroller unit. In a specific embodiment of the invention, the dummy memory circuit structure 10 is inserted into the slot of the motherboard to make the first serial clock pin SCLK1 of the microcontroller unit 200 on the dummy memory circuit structure 10 be coupled to the HSCL pin of the slot, and the first serial data input and output pin SDAT1 of the microcontroller unit 200 be coupled to the HSDA pin of the slot, so as to address the dummy memory circuit structure 10. In a specific embodiment of the invention, the addressing step further includes generating a clock line signal and a corresponding data line signal for transmission to the central processing unit. Specifically, the microcontroller unit 200 generates a clock line signal and a corresponding data line signal for transmission to the central processing unit disposed on the motherboard. When the dummy memory circuit structure 10 is inserted into the slot of the motherboard, the microcontroller unit 200 is coupled to the motherboard, and the microcontroller unit 200 can generate a clock line signal and a corresponding data line signal thorough a serial communication bus interface, and transmits the clock line signal and the corresponding data line signal to the central processing unit on the motherboard, such that the microcontroller unit 200 sends the dummy module specification information which simulates a module specification information that meets JEDEC standards by generating the clock line signal and transmitting the clock line signal and the data line signal to the central processing unit.

Step S120 is a first stage communication step. Please refer to FIGS. 10 and 11 at the same time. Step S120, involves sending a first control signal by the central processing unit of the motherboard, and transmitting the first control signal to a first serial clock pin SCLK1 and a first serial data input and output pin SDAT1 of the microcontroller unit 200 included in the dummy memory circuit structure through a HSCL (Host Bus-Input Clock) / HSDA (Host Bus-Data Input/Output) pin of the slot. In a specific embodiment of the invention, the microcontroller unit 200 makes communication with a central processing unit (not shown) by providing a clock line signal and a data line signal. Moreover, the central processing unit of the motherboard sends a first control signal C1, and the first control signal is transmitted to the SCLK / SDAT pin of a microcontroller unit 200 included in the dummy memory circuit structure 10 through the HSCL / HSDA pin of the slot. Specifically, in the first stage communication step, the microcontroller unit 200 generates a clock line signal through a serial communication bus interface (not shown) of the microcontroller unit 200, outputs the clock line signal through HSCL pin of the slot, and outputs the corresponding a data line signal through the HSCL pin of the slot to transmit the clock line signal and the data line signal on a data line to the central processing unit. In this way, in the addressing step, the dummy module specification information simulates a module specification information which meets JEDEC standards, so that the central processing unit can make communication with the microcontroller unit. That is, the microcontroller unit 200 can simulate a response of a memory chip complying with JEDEC regulations and enables communication between the microcontroller unit 200 and the central processing unit, regardless of its manufacturer.

Step S130 includes a second stage communication step. Please refer to FIGS. 10 and 11 at the same time. Step S130, involves processing the first control signal by the microcontroller unit 200 to generate a second control signal and then outputting the second control signal through the first serial clock pin SCLK1 and the first serial data input and output pin SDAT1 of the microcontroller unit 200, and transmitting the second control signal to a second serial clock pin SCLK2 and a second serial data input and output pin SDAT2 of a light emitting diode chip 300 included in the dummy memory circuit structure 10, thereby controlling the operation of at least one light emitting diode 400 included in the dummy memory circuit structure 10. In a specific embodiment of the invention, after the first control signal C1 is processed by the microcontroller unit 200, a second control signal C2 is outputted through the first serial clock pin SCLK1 and the first serial data input and output pin SDAT1 of the microcontroller unit 200. The second control signal C2 is transmitted to the second serial clock pin SCLK2 and the second serial data input and output pin SDAT2 of a light emitting diode chip 300 included in the dummy memory circuit structure 10. In a specific embodiment of this invention, the microcontroller unit 200 further includes a first device pin DE1 and a second device pin DE2. In this embodiment, the first device pin DE1 of the microcontroller unit 200 is coupled to the second serial clock pin SCLK2, and the second device pin DE2 of the microcontroller unit 200 is coupled to the second serial data pin SDAT2.

Step S130 further includes a light emitting diode driving step: after communication between the central processing unit and the microcontroller unit has been made, and after receiving the second control signal C2, the light emitting diode chip 300 provides a driving current to at least one light emitting diode 400 included in the dummy memory circuit structure 10 so as to control the operation of at least one light emitting diode 400 included in the dummy memory circuit structure 10, such as emitting light, flashing, or other operations. In some embodiments, the second voltage conversion circuit module is configured to convert the power providing voltage provided by the motherboard into a second voltage and to supply power to the light emitting diode control chip and the at least one light emitting diode, so that the light emitting diode control chip can make communication with the microcontroller unit and be capable of receiving a second control signal from the microcontroller unit.

In the above steps S110, S120, and S130, the central processing unit (not shown) on the motherboard (not shown) is configured to communicate directly with the microcontroller unit 200. Compared to the conventional dummy memory structure 10' of FIGS. 1 to 6, the central processing unit (not shown) does not need to identify the module specification information of the microcontroller unit 200 in the dummy memory circuit structure 10 of the present invention.

In some embodiments, the first stage communication step (i.e., step S120) may further include: converting a power supply voltage provided by the motherboard (not shown) into a first voltage through a first voltage conversion circuit module 500 included in the dummy memory circuit structure 10 and providing the first voltage to the microcontroller unit 200, such as the first power providing pin of the microcontroller unit 200, through the first output end, so that the microcontroller unit 200 can make communication with the central processing unit. In some embodiments, the power supply voltage may be greater than the first voltage. For example, the power supply voltage is 5V and the first voltage is 1V.

In some embodiments, the second stage communication step (i.e., step S130) may further include: converting the power supply voltage provided by the motherboard (not shown) into a second voltage through a second voltage conversion circuit module 600 included in the dummy memory circuit structure 10 and providing the second voltage to the LED control chip 300, such as the second power providing pin of the LED control chip 300, and at least one light emitting diode 400 through the second output end. Therefore, the microcontroller unit 200 can make communication with the LED control chip 300 and the LED control chip 300 receives the second control signal from the microcontroller unit 200. Moreover, the second stage communication step (i.e., step S130) may further include: converting the power supply voltage provided by the motherboard into the second voltage through a second voltage conversion circuit module 600 included in the dummy memory circuit structure 10 and providing the second voltage to and at least one LED 400, such as the third power providing pin of the at least one LED 400, through the third output end. Therefore, the at least one LED 400 receives a driving current from the LED control chip 300. In some embodiments, the power supply voltage may be greater than or equal to the second voltage, and the second voltage may be greater than the first voltage. For example, the second voltage is 3.3V to 5V.

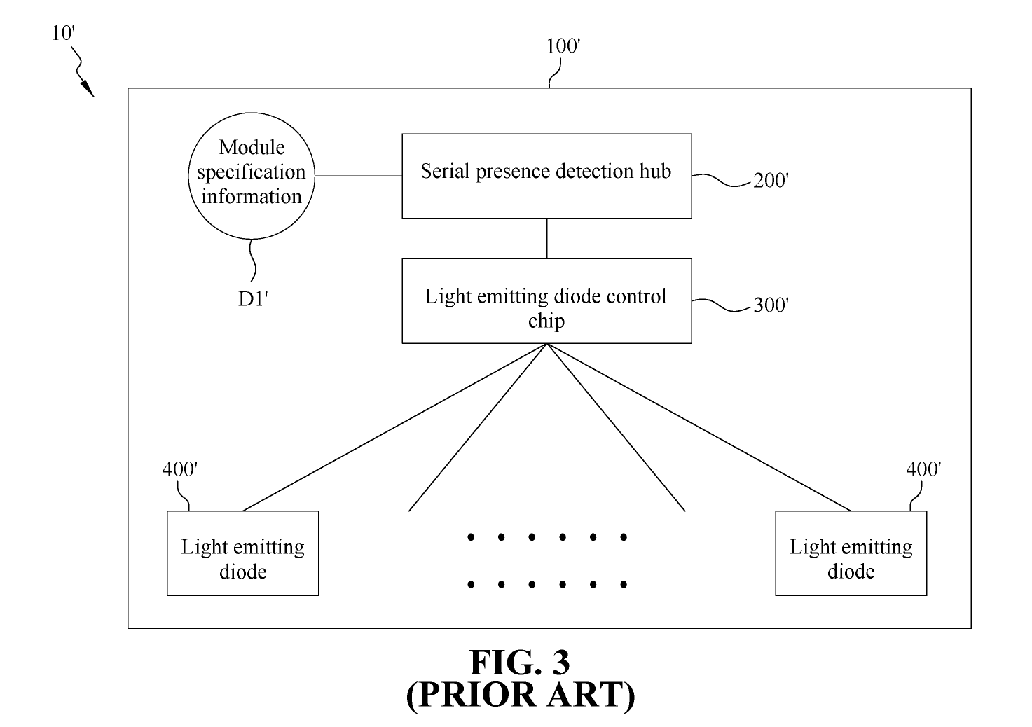

In summary, the dummy memory circuit structure 10 and the operation method S100 of the dummy memory circuit structure 10 of the present invention may be realized by configuring the microcontroller unit 200 and eliminating the sequence presence detection hub (referring to the sequence presence detection hub 200' in FIG. 3). Even if the dummy memory circuit structure 10 is used on a motherboard (not shown) with a central processing unit (not shown) made by a different manufacturer, it is possible to directly boot subsequent electronic devices such as computers and control the light-emitting diode 400 without having to identify the data content of the dummy memory circuit structure 10 (or, the microcontroller unit 200) itself.

The above descriptions are only used to explain the preferred embodiments of the present invention, and are not intended to limit the present invention in any form. Therefore, any modifications or changes made to the present invention under the same inventive spirit should still be included in the scope of protection intended by the present invention.

What is claimed is:

1. A dummy memory circuit structure, comprising:
a circuit substrate, configured to be detachably inserted into a slot of a motherboard on which a central processing unit is disposed;
a microcontroller unit, disposed on the circuit substrate;
a light emitting diode control chip, disposed on the circuit substrate, being electrically connected to the microcontroller unit through the circuit substrate; and
at least one light emitting diode, disposed on the circuit substrate, being electrically connected to the light emitting diode control chip through the circuit substrate;
wherein the microcontroller unit is configured to send a dummy module specification information to the central processing unit for identification of the circuit substrate, so that the central processing unit can make communication with the microcontroller unit.

2. The dummy memory circuit structure according to claim 1, wherein the dummy module specification information is configured to simulate a module specification information which meets JEDEC standards.

3. The dummy memory circuit structure according to claim 1, wherein the microcontroller unit is configured to send a dummy module specification information by generating a clock line signal through a serial communication bus interface of the microcontroller unit, outputting the clock line signal through a HSCL pin of the slot, and outputting a corresponding data line signal through a HSDA pin of the slot to transmit the clock line signal and the data line signal to the central processing unit.

4. The dummy memory circuit structure according to claim 1, wherein the microcontroller unit further comprises a serial communication bus interface.

5. The dummy memory circuit structure according to claim 4, wherein the serial communication bus interface comprises I²C, I³C or a combination thereof.

6. The dummy memory circuit structure according to claim 1, wherein the microcontroller unit further comprises a first device pin and a second device pin, and the light emitting diode control chip comprises a second serial clock pin and a second serial data input and output pin, and
wherein the first device pin is coupled to the second serial clock pin, and the second device pin is coupled to the second serial data input and output pin.

7. The dummy memory circuit structure according to claim 1, further comprising a first voltage conversion circuit module, disposed on the circuit substrate, and comprising a first input end and a first output end,
wherein the microcontroller unit further comprises a first power providing pin; and
wherein the first input end is electrically connected to the motherboard, and the first output end is electrically connected to the power providing pin, so that the first voltage conversion circuit module is electrically connected to the motherboard and the microcontroller unit.

8. The dummy memory circuit structure according to claim 7, further comprising a second voltage conversion circuit module, disposed on the circuit substrate, and comprising a second input end and a second output end,
wherein the light emitting diode control chip further comprises a second power providing pin,
wherein the second input end is electrically connected to the motherboard, the second output end is electrically connected to the second power providing pin, so that the second voltage conversion circuit module is electrically connected to the motherboard and the light emitting diode control chip,
wherein the second voltage conversion circuit module further comprises a third input end and a third output end,
wherein the light emitting diode control chip further comprises a third power providing pin, and
wherein the third input end is electrically connected to the motherboard, the third output end is electrically connected to the third power providing pin, so that the second voltage conversion circuit module is electrically connected to the motherboard and the at least one light emitting diode.

9. The dummy memory circuit structure according to claim 8, wherein the first voltage conversion circuit module is configured to convert a power providing voltage provided by the motherboard into a first voltage and to supply power to the microcontroller unit, so that the microcontroller unit can make communication with the central processing unit and be capable of receiving a first control signal from the central processing unit, and
wherein the second voltage conversion circuit module is configured to convert the power providing voltage provided by the motherboard into a second voltage and to supply power to the light emitting diode control chip and the at least one light emitting diode, so that the light emitting diode control chip can make communication with the microcontroller unit and be capable of receiving a second control signal from the microcontroller unit.

10. The dummy memory circuit structure according to claim 9, wherein the power supply voltage is greater than or equal to the second voltage, and the second voltage is greater than the first voltage.

11. The dummy memory circuit structure according to claim 1, wherein the microcontroller unit and the light emitting diode control chip are integrated into a single chip.

12. A computer device comprising:
a motherboard on which a central processing unit is disposed;
a circuit substrate detachably inserted into a slot of the motherboard;
a microcontroller unit disposed on the circuit substrate;
a light emitting diode control chip disposed on the circuit substrate, being electrically connected to the microcontroller unit through the circuit substrate; and
at least one light emitting diode disposed on the circuit substrate, electrically connected to the light emitting diode control chip through the circuit substrate;
wherein the microcontroller unit is configured to send a dummy module specification information to the central processing unit for identification of the circuit substrate, so that the central processing unit can make communication with the microcontroller unit.

13. An operation method of a dummy memory circuit structure, comprising:
an addressing step: inserting a dummy memory circuit structure into a slot of a motherboard to address the dummy memory circuit structure, wherein a microcontroller unit included in the dummy memory circuit structure sends a dummy module specification information to a central processing unit of the motherboard, so that the central processing unit can make communication with the microcontroller unit;
a first stage communication step: sending a first control signal by the central processing unit of the motherboard, and transmitting the first control signal to a first serial clock pin and a first serial data input and output pin of the microcontroller unit included in the dummy memory circuit structure through a HSCL (Host Bus-Input Clock) / HSDA (Host Bus-Data Input/Output) pin of the slot; and
a second stage communication step: processing the first control signal by the microcontroller unit to generate a second control signal, outputting the second control signal through the first serial clock pin and the first serial data input and output pin of the microcontroller unit, and transmitting the second control signal to a second serial clock pin and a second serial data input and output pin of a light emitting diode chip included in the dummy memory circuit structure, thereby controlling the operation of at least one light emitting diode included in the dummy memory circuit structure.

14. The operation method according to claim 13, wherein the addressing step includes generating a clock line signal and a corresponding data line signal for transmission to the central processing unit.

15. The operation method according to claim 14, wherein the microcontroller unit further comprises a first device pin and a second device pin, and
wherein in the first stage communication step, the first device pin is coupled to the second serial clock pin, and the second device pin is coupled to the second serial data input and output pin.

16. The operation method according to claim 13, wherein in the addressing step, the dummy module specification information simulates a module specification information which meets JEDEC standards, so that the central processing unit can make communication with the microcontroller unit.

17. The operation method according to claim 14, wherein the first stage communication step further includes converting a power supply voltage provided by the motherboard into a first voltage through a first voltage conversion circuit module included in the dummy memory circuit structure and providing the first voltage to the microcontroller unit.

18. The operation method according to claim 17, wherein the second stage communication step further includes converting the power supply voltage provided by the motherboard into a second voltage through a second voltage conversion circuit module included in the dummy memory circuit structure and providing the second voltage to a light emitting diode control chip and the at least one light emitting diode.

19. The operation method according to claim 18, wherein the power supply voltage is greater than or equal to the second voltage, and the second voltage is greater than the first voltage.

20. The operation method according to claim 18, wherein the power supply voltage is 5V, the first voltage is 1V, and the second voltage is 3.3V to 5V.
